(19) United States
(12) Patent Application Publication
(10) Pub. No.: US 2023/0192132 A1
(43) Pub. Date: Jun. 22, 2023

(54) AUTONOMOUS DRIVING CONTROL APPARATUS AND METHOD THEREOF

(71) Applicants: HYUNDAI MOTOR COMPANY, Seoul (KR); Kia Corporation, Seoul (KR)

(72) Inventor: Tae Dong OH, Seoul (KR)

(73) Assignees: HYUNDAI MOTOR COMPANY, Seoul (KR); Kia Corporation, Seoul (KR)

(21) Appl. No.: 17/880,058

(22) Filed: Aug. 3, 2022

(30) Foreign Application Priority Data
Nov. 18, 2021 (KR) 10-2021-0159632

(51) Int. Cl. B60W 60/00; G01C 21/00; G01C 21/34

(52) U.S. Cl. CPC B60W 60/0011; B60W 60/00272; G01C 21/3492; G01C 21/3807; B60W 2300/145; B60W 2554/80; B60W 2554/4041; B60W 2554/4044

(57) ABSTRACT

An autonomous driving control apparatus for determining a driving path of an autonomous vehicle and a method thereof are provided. A path calculation device calculates paths swept by a part or all of a body of an autonomous vehicle with respect to two or more driving path candidates of the autonomous vehicle. A controller determines risks for the two or more driving path candidates based on the swept paths, and determines a driving path of the autonomous vehicle based on the risks determined for the two or more driving path candidates. The autonomous driving control apparatus prevents a risk of collision between a trailer part and an object to ensure stability of autonomous driving.

### CROSS-REFERENCE TO RELATED APPLICATION

The present application claims the benefit of priority to Korean Patent Application No. 10-2021-0159632, filed on Nov. 18, 2021 in the Korean Intellectual Property Office, the entire contents of which are incorporated herein by reference.

### TECHNICAL FIELD

The present disclosure relates to an autonomous driving control apparatus and a method thereof, and more particularly, relates to an autonomous driving control apparatus for determining a driving path of an autonomous vehicle and a method thereof.

### BACKGROUND

An autonomous vehicle capable of performing driving, braking, and steering on behalf of a driver to reduce the fatigue of the driver requires an ability to respond adaptively according to a surrounding situation which is changed in real time while driving. First of all, a reliable determination control function is required to mass produce and activate autonomous vehicles. Recently, the autonomous vehicle is loaded with a highway driving assist (HDA) function, a driver status warning (DSW) function of determining driver carelessness, such as drowsy driving or gaze departure, and state abnormality and outputting a warning alarm through a cluster or the like, a driver awareness warning (DAW) function of identifying whether the vehicle crosses the line and performs unstable driving by means of a front view camera, a forward collision-avoidance assist (FCA) or active emergency brake system (AEBS) function of performing emergency braking when detecting a head on collision, or the like to be sold.

In addition, for fully autonomous driving, when a user enters a destination, the autonomous vehicle sets a path by itself and drives to provide driving to the destination. Particularly, because a truck or a commercial vehicle including a trailer and a tractor has different paths swept by the tractor and the trailer, there is a need to develop a technology of determining a driving path considering a risk of driving based on paths in which both areas swept by the tractor and the trailer are reflected.

The information disclosed in the Background section above is to aid in the understanding of the background of the present disclosure, and should not be taken as acknowledgement that this information forms any part of prior art.

### SUMMARY

The present disclosure has been made to solve the above-mentioned problems occurring in the prior art while advantages achieved by the prior art are maintained intact.

An aspect of the present disclosure provides an autonomous driving control apparatus for determining a driving path of an autonomous vehicle and a method thereof.

Another aspect of the present disclosure provides an autonomous driving control apparatus for improving driving stability of an autonomous vehicle including a tractor and a trailer and a method thereof.

Another aspect of the present disclosure provides an autonomous driving control apparatus for preventing a risk of collision between a trailer and an object and a method thereof.

Another aspect of the present disclosure provides an autonomous driving control apparatus for improving riding quality of a user according to a curvature of a path, and a method thereof.

Another aspect of the present disclosure provides an autonomous driving control apparatus for minimizing a detour distance to provide natural driving like a person actually driving the autonomous vehicle and a method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an autonomous driving control apparatus may include a path calculation device that calculates paths swept by a part or all of the body of an autonomous vehicle with respect to two or more driving path candidates of the autonomous vehicle; and a controller that determines risks to the two or more driving path candidates based on the swept paths, and determines a driving path of the autonomous vehicle based on the risks determined for the two or more driving path candidates.

In an exemplary embodiment, the autonomous vehicle may include a tractor part and a trailer part. The path calculation device may calculate the paths swept by the part or all of the body of the autonomous vehicle, based on a path swept by the tractor part with respect to each of the two or more driving path candidates and a path swept by the trailer part with respect to each of the two or more driving path candidates.

In an exemplary embodiment, the controller may determine the risks, based on the swept paths, according to at least one of a position occupied by an object around each of the two or more driving path candidates or a position determined as being occupied in the future by the object around each of the two or more driving path candidates.

In an exemplary embodiment, the controller may generate a grid map where information about the at least one of the position occupied by the object around each of the two or more driving path candidates or the position determined as being occupied in the future by the object around each of the two or more driving path candidates is reflected in a grid and may determine the risks, based on the grid map and the swept paths.

In an exemplary embodiment, the controller may generate the grid map with respect to a current time point and the grid map with respect to a future time point and may determine the risks, based on the grid map with respect to the current time point, the grid map with respect to the future time point, and the swept paths.

In an exemplary embodiment, the controller may generate the grid map where information about at least one of a size or a type of a vehicle around each of the two or more driving path candidates is reflected in the grid.

In an exemplary embodiment, the controller may calculate a probability that the object will occupy a position corresponding to the grid in the future and may generate the grid map where the probability is reflected in the grid.

In an exemplary embodiment, the controller may calculate the probability that the object will occupy the position corresponding to the grip in the future, based on at least one of a driving direction, a speed, or a stop distance of the object.

In an exemplary embodiment, the controller may determine at least one of driving stability or a detour degree corresponding to each of the two or more driving path candidates and may determine the driving path according to the at least one of the driving stability or the detour degree.

In an exemplary embodiment, the controller may determine the driving stability, based on a curvature of each of the two or more driving path candidates.

In an exemplary embodiment, the controller may determine the driving stability, based on at least one of an average curvature of the two or more driving path candidates, a maximum curvature of the two or more driving path candidates, or a weighted average of the average curvature and the maximum curvature.

In an exemplary embodiment, the controller may determine the detour degree, based on at least one of a detour distance or a detour time of each of the two or more driving path candidates, according to a reference path.

In an exemplary embodiment, the controller may calculate at least one of scores according to the risks, a score according to the driving stability, or a score according to the detour degree and may determine the driving path of the autonomous vehicle, based on a weighted sum or a weighted average of at least one of the scores according to the risks, the score according to the driving stability, or the score according to the detour degree.

In an exemplary embodiment, the controller may determine a following speed, based on at least one of a curvature of the driving path or a forward object on the path, which corresponds to the driving path, swept by the part or all of the body of the autonomous vehicle, and may perform autonomous driving control of the autonomous vehicle depending on the following speed.

According to an aspect of the present disclosure, an autonomous driving control method may include calculating, by a path calculation device, paths swept by a part or all of a body of an autonomous vehicle with respect to two or more driving path candidates of the autonomous vehicle, determining, by a controller, risks for the two or more driving path candidates based on the swept paths, and determining, by the controller, a driving path of the autonomous vehicle based on the risks determined for the two or more driving path candidates.

In an exemplary embodiment, the determining of the risks for the two or more driving path candidates by the controller may include generating, by the controller, a grid map where information about at least one of a position occupied by an object around each of the two or more driving path candidates or a position determined as being occupied in the future by the object around each of the two or more driving path candidates is reflected in a grid and determining, by the controller, the risks, based on the grid map and the swept paths.

In an exemplary embodiment, the generating of the grid map by the controller may include calculating, by the controller, a probability that the object will occupy a position corresponding to the grid in the future and generating, by the controller, the grid map where the probability is reflected in the grid.

In an exemplary embodiment, the autonomous driving control method may further include determining, by the controller, driving stability corresponding to each of the two or more driving path candidates, based on a curvature of each of the two or more driving path candidates. The determining of the driving path of the autonomous vehicle by the controller may include determining, by the controller, the driving path according to the driving stability.

In an exemplary embodiment, the autonomous driving control method may further include determining, by the controller, a detour degree corresponding to each of the two or more driving path candidates, based on at least one of a detour distance or a detour time of each of the two or more driving path candidates, according to a reference path. The determining of the driving path of the autonomous vehicle by the controller may include determining, by the controller, the driving path according to the detour degree.

In an exemplary embodiment, the autonomous driving control method may further include determining, by the controller, at least one of driving stability or a detour degree corresponding to each of the two or more driving path candidates. The determining of the driving path of the autonomous vehicle by the controller may include calculating, by the controller, at least one of scores according to the risks, a score according to the driving stability, or a score according to the detour degree and determining, by the controller, the driving path of the autonomous vehicle, based on a weighted sum or a weighted average of at least one of the scores according to the risks, the score according to the driving stability, or the score according to the detour degree.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating an autonomous driving control apparatus according to an exemplary embodiment of the present disclosure;

FIG. 2 is a block diagram illustrating a detailed configuration of an autonomous driving control apparatus according to an exemplary embodiment of the present disclosure;

FIG. 3 is a flowchart illustrating an operation of an autonomous driving control apparatus according to an exemplary embodiment of the present disclosure;

FIG. 4A and FIG. 4B are drawings illustrating that an autonomous driving control apparatus generates a grid map according to an exemplary embodiment of the present disclosure;

FIGS. 5A and 5B are drawings illustrating that an autonomous driving control apparatus generates a grid map at a future time point according to an exemplary embodiment of the present disclosure;

FIGS. 6A and 6B are drawings illustrating that an autonomous driving control apparatus generates a grid map in which a size of a surrounding vehicle is reflected according to an exemplary embodiment of the present disclosure;

FIGS. 7A, 7B, 7C, and 7D are drawings illustrating that an autonomous driving control apparatus compares driving path candidates based on a grid map over time according to an exemplary embodiment of the present disclosure;

FIG. 8 is a drawing illustrating that an autonomous driving control apparatus determines a risk according to an exemplary embodiment of the present disclosure;

FIG. 9A and FIG. 9B are drawings illustrating that an autonomous driving control apparatus determines driving stability according to another exemplary embodiment of the present disclosure;

FIG. 10A and FIG. 10B are drawings illustrating that an autonomous driving control apparatus determines a detour degree according to an exemplary embodiment of the present disclosure;

FIG. 11 is a drawing illustrating that an autonomous driving control apparatus determines a final driving path according to an exemplary embodiment of the present disclosure;

FIG. 12 is a drawing illustrating that an autonomous driving control apparatus calculates a speed profile according to an exemplary embodiment of the present disclosure; and

FIG. 13 is a flowchart illustrating an autonomous driving control method according to an exemplary embodiment of the present disclosure.

### DETAILED DESCRIPTION

Hereinafter, some embodiments of the present disclosure will be described in detail with reference to the exemplary drawings. In the drawings, the same reference numerals will be used throughout to designate the same or equivalent elements. In addition, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Furthermore, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

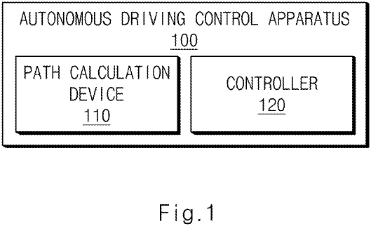

Hereinafter, embodiments of the present disclosure will be described in detail with reference to FIGS. 1 to 13.

FIG. 1 is a block diagram illustrating an autonomous driving control apparatus according to an exemplary embodiment of the present disclosure.

An autonomous driving control apparatus 100 according to an exemplary embodiment of the present disclosure may be implemented inside or outside a vehicle. In this case, the autonomous driving control apparatus 100 may be integrally configured with control units in the vehicle or may be implemented as a separate hardware device to be connected with the control units of the vehicle by a connection means.

As an example, the autonomous driving control apparatus 100 may be integrally configured with the vehicle or may be implemented as a separate configuration independent of the vehicle in the form of being installed/attached to the vehicle. Alternatively, a part of the autonomous driving control apparatus 100 may be integrally configured with the vehicle and the other may be implemented as a separate configuration independent of the vehicle in the form of being installed/attached to the vehicle.

Referring to FIG. 1, the autonomous driving control apparatus 100 may include a path calculation device 110 and a controller 120.

The path calculation device 110 may calculate paths swept by a part or all of the body of an autonomous vehicle with respect to two or more driving path candidates of the autonomous vehicle.

As an example, the autonomous vehicle may include a tractor part and a trailer part.

The trailer part may refer to a vehicle which is connected with a rear part of a vehicle such as a truck or a tractor to be towed. In general, the trailer part may be used for receiving cargo.

The tractor part may refer to a vehicle which is connected with the trailer part to tow the trailer part. As an example, the tractor part may include a truck or a tractor.

The structure where the tractor part and the trailer part are connected with each other is generally and frequently used in a commercial vehicle.

As an example, the driving path candidate and the path swept by the part or all of the body of the autonomous driving with respect to the driving path candidate may include a path determined on a two-dimensional (2D) map.

As an example, the driving path candidate may refer to a path candidate, generated by a previously generated algorithm, on which the autonomous vehicle travels from a current position to a destination.

As an example, the path swept by the part or all of the body of the autonomous vehicle may refer to an area swept by the part or all of the body of the autonomous vehicle, when the autonomous vehicle drives along the driving path candidate.

As an example, the path calculation device 110 may calculate one or more driving path candidates based on the current position identified by means of a global positioning system (GPS) or the like of the autonomous vehicle and the destination input by a user.

As an example, the path calculation device 110 may calculate a path swept by a part or all of the body of the autonomous vehicle, based on a path swept by the tractor part with respect to the driving path candidate and a path swept by the trailer part with respect to the driving path candidate.

As an example, the path calculation device 110 may calculate a union area of an area for the path swept by the tractor part with respect to the driving path candidate and an area for the path swept by the trailer part with respect to the driving path candidate as the path swept by the part or all of the body of the autonomous vehicle.

As an example, the path calculation device 110 may include one or more processors (e.g., computer, microprocessor, CPU, ASIC, circuitry, logic circuits, etc.) for perform the described function.

As an example, the path calculation device 110 may be directly or indirectly connected with the controller 120 through wireless or wired communication to deliver information about the calculated driving path candidate and the path swept by the part or all of the body of the autonomous vehicle to the controller 120.

The controller 120 may perform the overall control such that respective components may normally perform their own functions. Such a controller 120 may be implemented in the form of hardware, may be implemented in the form of software, or may be implemented in the form of a combination thereof. Preferably, the controller 120 may be implemented as, but not limited to, a microprocessor. In addition, the controller 120 may perform a variety of data processing, calculation, and the like described below.

The controller 120 may be electrically connected with the path calculation device 110 or the like and may electrically control the respective components. The controller 120 may be an electrical circuit which executes instructions of software and may perform a variety of data processing and calculation described below. The controller 120 may be, for example, an electronic control unit (ECU), a micro controller unit (MCU), or another sub-controller, which is loaded into the vehicle.

The controller 120 may determine risks to two or more driving path candidates, based on the path swept by the part or all of the body of the autonomous vehicle.

As an example, the controller 120 may determine the risk to the driving path candidate, based on whether there is a portion where an area of the path swept by the part or all of the body of the autonomous vehicle and an area occupied by an object around the swept path are overlapped with each other.

As an example, the controller 120 may determine a risk, based on the path swept by the part or all of the body of the autonomous vehicle according to at least one of a position occupied by an object around the driving path candidate or a position determined as being occupied in the future by the object around the driving path candidate.

As an example, the controller 120 may determine a risk to the driving path candidate, based on whether there is a portion where an area of the path swept by the part or all of the body of the autonomous vehicle is overlapped with an area occupied by an object around the swept path or an area which will be occupied in the future by the object around the swept path.

As an example, the controller 120 may generate a grid map where information about at least one of a position occupied by an object around the driving path candidate or a position determined as being occupied in the future by the object around the driving path candidate is reflected in a grip and may determine a risk, based on the grid map and the path swept by the part or all of the body of the autonomous vehicle.

In detail, the controller 120 may generate a grid map to which a risk score of each grid is assigned, according to a type of an object occupying a position corresponding to each grid, a size of the object, a probability of occupying the position corresponding to each grip in the future, or the like.

Herein, as an example, because the risk score is calculated as a lower score as the risk is higher, a path candidate having the highest final risk score may be determined as the safest path.

As another example, because the risk score is calculated as a higher score as the risk is higher, a path candidate having the lowest final risk score may be determined as the safest path.

Furthermore, the controller 120 may add risk scores of grids overlapped with the area for the path swept by the part or all of the body of the autonomous vehicle to calculate a final risk score of the driving path candidate.

As an example, the controller 120 may generate a grid map with respect to a current time point and a grip map with respect to a future time point and may determine a risk, based on the grid map with respect to the current time point, the grip map with respect to the future time point, and the path swept by the part or all of the body of the autonomous vehicle.

As an example, the controller 120 may calculate a risk score of each of the grid map with respect to the current time point and the grip map with respect to the future time point and may calculate a final risk score of the driving path candidate by means of an average or a weighted average of the calculated scores.

As an example, the controller 120 may generate a grid map where information about at least one of a size or a type of a vehicle around the driving path candidate is reflected in a grip.

As an example, when the surrounding object is a vehicle, because there is a different risk upon collision depending on a size of the surrounding vehicle, the controller 120 may assign a risk score corresponding to the grid of the grid map according to the size of the surrounding vehicle. The larger the size of the surrounding vehicle, the larger the risk is upon collision.

As an example, the controller 120 may assign a risk score corresponding to the grid of the grid map according to a height, a width, and a length of the surrounding vehicle.

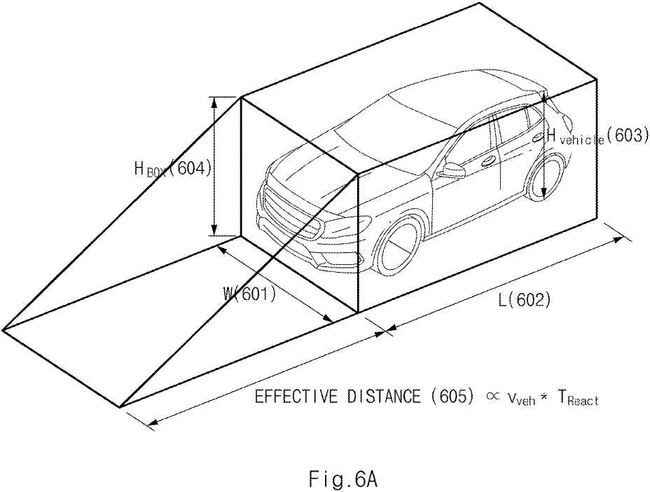

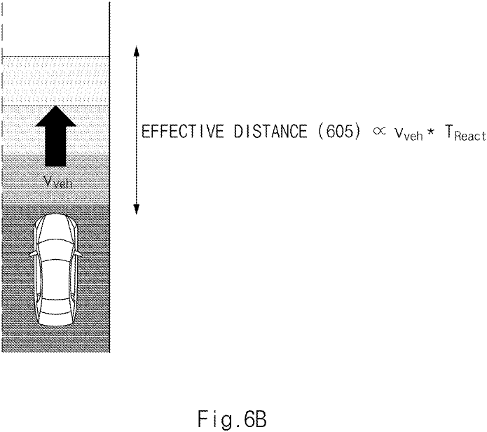

As an example, the controller 120 may generate a virtual height model corresponding to the surrounding vehicle to consider both of the size of the surrounding vehicle and a probability that the surrounding vehicle will occupy a specific position in the future. A description will be given in detail below of it with reference to FIGS. 6A and 6B.

As an example, the controller 120 may calculate a probability that the surrounding object will occupy a position corresponding to the grip in the future and may generate a grip map where the probability is reflected in the grip.

As an example, the controller 120 may calculate the probability that the surrounding object will occupy the position corresponding to the grip in the future, based on at least one of a driving direction, a speed, or a stop distance of the surrounding object.

When the surrounding object is a vehicle, the controller 120 may determine that a probability that the surrounding object will occupy an area in front of the surrounding object in the future is high, depending on the driving direction of the surrounding object.

As an example, when the speed of the surrounding object is high or when the stop distance of the surrounding object is long, the controller 120 may determine that a probability that the surrounding object will occupy a long area in front of the surrounding object in the future.

Furthermore, when the surrounding object is a fixed wall, a curb stone, a sign, a forest, a structure, or the like, the controller 120 may determine that a probability that the surrounding object will occupy the area in the future is very high.

As an example, the controller 120 may assign a risk score according to the probability that the surrounding object will occupy the position corresponding to the grid in the future to the grid.

As an example, as the probability that the surrounding object will occupy the position corresponding to the grip in the future is higher, the controller 120 may determine that a risk of the grid is higher.

The controller 120 may determine a driving path of the autonomous vehicle, based on the risks determined for the two or more driving path candidates.

As an example, the controller 120 may determine a driving path candidate having the lowest risk among the two or more driving path candidates as a driving path of the autonomous vehicle.

As an example, when the higher the risk, the lower the risk score is assigned to be, the controller 120 may determine a driving path candidate having the highest risk score among the two or more driving path candidates as a driving path of the autonomous vehicle.

As an example, the controller 120 may determine at least one of driving stability or a detour degree corresponding to the driving path candidate and may determine a driving path according to at least one of the driving stability or the detour degree.

The higher the driving stability, the better the riding quality of the passenger.

As an example, the controller 120 may determine driving stability, based on a curvature of the driving path candidate.

As an example, when the autonomous vehicle travels along the driving path candidate, the controller 120 may determine driving stability of the driving path candidate, based on a curvature of a curve connecting paths where the center or a feature point of the autonomous vehicle or a tractor part moves.

In detail, the controller 120 may determine driving stability, based on at least one of an average curvature of the driving path candidates, a maximum curvature of the driving path candidates, or a weighted average of the average curvature and the maximum curvature.

As an example, because the larger the curvature, the lower the driving stability, the controller 120 may assign a higher driving stability score to the driving path candidate as at least one of the average curvature of the driving path candidates, the maximum curvature of the driving path candidates, or the weighted average of the average curvature and the maximum curvature is lower.

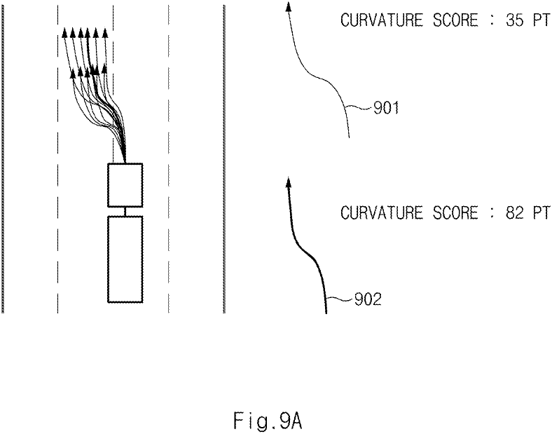

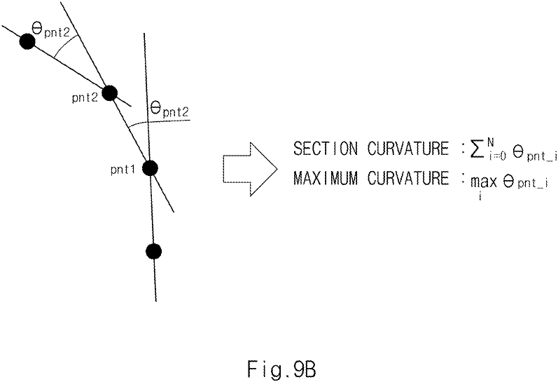

A description will be given in detail below of the case where the controller 120 determines the driving stability corresponding to the driving path candidate with reference to FIGS. 9A and 9B.

As an example, the controller 120 may determine a detour degree, based on at least one of a detour distance or a detour time of the driving path candidate, according to a reference path.

As an example, the reference path may refer to a path where the center or a feature point of the tractor moves, when the autonomous vehicle travels along a path on a navigation map.

As an example, the reference path may include a path where the autonomous vehicle travels along the center of a lane where the autonomous vehicle is traveling.

As an example, the controller 120 may calculate the shortest distance to the driving path candidate with reference to each reference point included in the reference path and may determine a detour degree of the driving path candidate, based on the calculated shortest distance.

Herein, the shortest distance to the driving path candidate may refer to a path where the center or a feature point of the tractor part moves, when the autonomous vehicle travels along the driving path candidate.

As an example, the controller 120 may calculate a time more delayed due to path detour when the autonomous vehicle travels along the driving path candidate than when the autonomous vehicle travels along the reference path and may determine a detour degree of the driving path candidate based on the calculated time.

As an example, as the detour distance and/or a detour time is shorter, the controller 120 may assign a higher detour degree score to the driving path candidate.

As the detour degree score is higher, it may feel like a person actually drives the vehicle.

As an example, the controller 120 may also determine a detour degree for the trailer part and may calculate a final detour degree according to the detour degree determined for the trailer part and the detour degree determined for the tractor part.

As an example, the controller 120 may perform an average or a weighted average of a score according to the detour degree determined for the trailer part and a score according to the detour degree determined for the tractor part.

As an example, the controller 120 may calculate at least one of a score according to the risk, a score according to the driving stability, or a score according to the detour degree and may determine a driving path of the autonomous vehicle, based on a weighted sum or a weighted average of at least one of the score according to the risk, the score according to the driving stability, or the score according to the detour degree. Basically, the weight may be assigned as “1”, but may be adjusted according an embodiment.

As an example, the controller 120 may determine a driving path candidate, having the highest score which is the weight sum or the weight average, as a driving path of the autonomous vehicle.

As an example, the controller 120 may determine a following speed, based on at least one of a curvature of the driving path or a forward object on the path swept by the part or all of the body of the autonomous vehicle, which corresponds to the driving path.

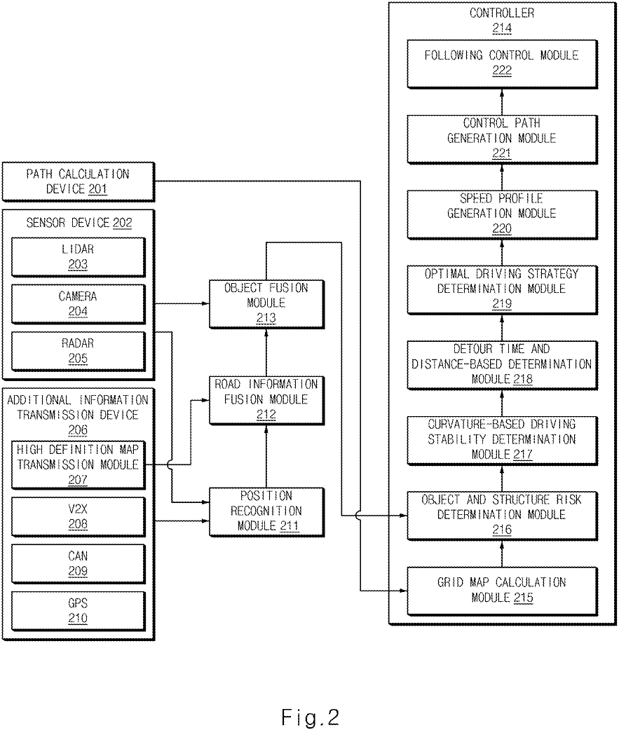

FIG. 2 is a block diagram illustrating a detailed configuration of an autonomous driving control apparatus according to an exemplary embodiment of the present disclosure.

Referring to FIG. 2, a path calculation device 201 may calculate two or more driving path candidates and a path swept by a part or all of the body of an autonomous vehicle according to each of the driving path candidates and may transmit information about the path to a grid map calculation module 215.

A sensor device 202 may include, for example, a light detection and ranging (LiDAR) 203, a camera 204, and a radar 205.

Recognition information about another vehicle, which is obtained by means of the LiDAR 203, the camera 204, and the radar 205 of the sensor device 202, may be transmitted to an object fusion module 213 and a position recognition module 211.

An additional information transmission device 206 may include a high definition map transmission module 207, a vehicle-to-everything (V2X) 208, a controller area network (CAN) 209, and a GPS 210.

The high definition map transmission module 207 may transmit information about a high definition map around the autonomous vehicle to a road information fusion module 212 and the position recognition module 211.

The V2X 208 may transmit information about the other vehicle, which is obtained through V2X communication, to the road information fusion module 212 and the position recognition module 211.

The position recognition module 211 may be communicatively connected with the CAN 209 of the autonomous vehicle to perform a communication function and may be connected with the GPS 210 of the autonomous vehicle to obtain position information of the autonomous vehicle.

The position recognition module 211 may compare the recognition information obtained by means of the sensor device 202, the information obtained by means of the GPS 210, and the high definition map information transmitted from the high definition map transmission module 207 and may output position information of the autonomous vehicle and reliability of position recognition together to be transmitted to the road information fusion module 212.

The road information fusion module 212 may output high definition map information around the autonomous vehicle, by means of the position recognition information and the high definition map information, to be transmitted to the object fusion module 213.

The object fusion module 213 may fuse and output an object on the high definition map, by means of the recognition information obtained by means of the sensor device 202 and the high definition map information around the autonomous vehicle, which is received from the road information fusion module 212, and may transmit the output information to an object and structure risk determination module 216.

As an example, the object may include another vehicle around the autonomous vehicle.

A controller 214 may include a processor (e.g., computer, microprocessor, CPU, ASIC, circuitry, logic circuits, etc.) and an associated non-transitory memory storing software instructions which, when executed by the processor, provides the functionalities of the grid map calculation module 215, the object and structure risk determination module 216, a curvature-based driving stability determination module 217, a detour time and distance-based determination module 218, an optimal driving strategy determination module 219, a speed profile generation module 220, a control path generation module 221, and a following control module 222.

The grid map calculation module 215 may generate a grid map around the driving path candidate and may deliver information about the grid map to the object and structure risk determination module 216.

The object and structure risk determination module 216 may determine a risk of a surrounding vehicle, a two-wheeled vehicle, a pedestrian, a forest, a structure, and/or the like on the grid map and may represent the risk on the grid map.

The object and structure risk determination module 216 may compare the grid map with a path swept by a part or all of the body of the autonomous vehicle to determine a risk of the driving path candidate and may deliver information about the risk to the driving path candidate to the curvature-based driving stability determination module 217.

The curvature-based driving stability determination module 217 may determine driving stability for the driving path candidate, based on a curvature according to a predicted path of a tractor part and a trailer part of the autonomous vehicle, and may deliver information about the driving stability for the driving path candidate to the detour time and distance-based determination module 218.

The detour time and distance-based determination module 218 may determine a detour time and/or a detour distance according to the predicted path of the tractor part and the trailer part of the autonomous vehicle, based on a reference path.

The detour time and distance-based determination module 218 may determine a detour degree of the driving path candidate, based on the detour time and/or the detour distance, and may deliver information about the determined detour degree to the optimal driving strategy determination module 219.

The optimal driving strategy determination module 219 may synthesize results of the risk, the driving stability, and the detour degree to determine an optimal driving strategy and may deliver information about the optimal driving strategy to the speed profile generation module 220.

Herein, the optimal driving strategy may include a final driving path.

The speed profile generation module 220 may generate a speed profile following the optimal driving strategy and may deliver information about the speed profile to the control path generation module 221.

The control path generation module 221 may generate a control path meeting the optimal driving strategy and the speed profile and may deliver information about the control path and the speed profile to the following control module 222.

The following control module 222 may perform autonomous driving of the autonomous vehicle according to the speed profile and the control path.

The components 211 to 222 may be implemented by means of one or more processors, and each module may be implemented in the form of software or hardware.

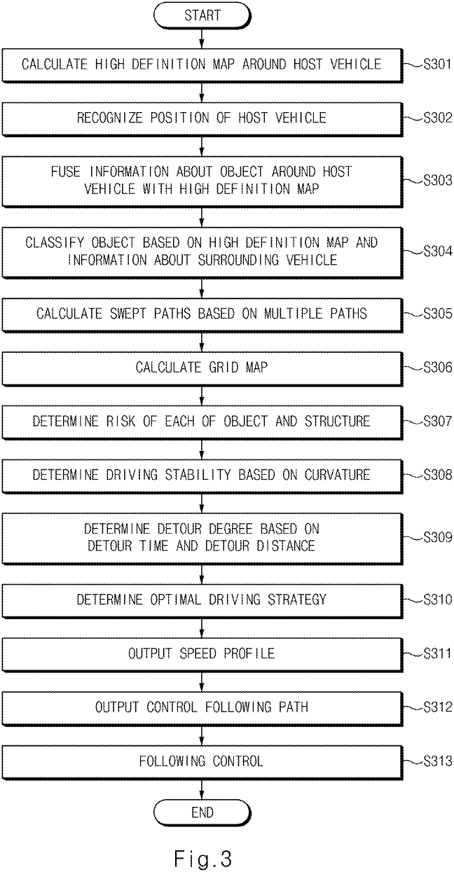

FIG. 3 is a flowchart illustrating an operation of an autonomous driving control apparatus according to an exemplary embodiment of the present disclosure.

Referring to FIG. 3, in S301, an autonomous driving control apparatus 100 of FIG. 1 may calculate a high definition map around a host vehicle.

As an example, the autonomous driving control apparatus 100 may receive information about the high definition map around the host vehicle from a server or a surrounding vehicle or may calculate information about the high definition map around the host vehicle by means of high definition map information previously stored in a memory.

In S302, the autonomous driving control apparatus 100 may recognize a position of the host vehicle.

As an example, the autonomous driving control apparatus 100 may recognize a position of the host vehicle by means of a GPS provided in the host vehicle.

In S303, the autonomous driving control apparatus 100 may fuse information about an object around the host vehicle with the high definition map.

As an example, the autonomous driving control apparatus 100 may fuse the information about the object around the host vehicle, which is obtained by means of one or more sensors provided in the host vehicle, with high definition map information to represent the object on the high definition map.

In S304, the autonomous driving control apparatus 100 may classify the object based on the high definition map and information about a surrounding vehicle.

As an example, the autonomous driving control apparatus 100 may determine a type of the detected object around the host vehicle, based on information about a structure on the high definition map and/or information about a position of the surrounding vehicle, which is received by means of V2X communication.

As an example, the autonomous driving control apparatus 100 may classify the object around the host vehicle as a vehicle, a structure, a forest, a sign, a two-wheeled vehicle, a pedestrian, or the like.

In S305, the autonomous driving control apparatus 100 may calculate information about swept paths based on multiple paths.

As an example, the autonomous driving control apparatus 100 may generate one or more driving path candidates by means of a predetermined algorithm and may calculate information about a path area swept by a part or all of the body of the autonomous vehicle, when the autonomous vehicle travels along the generated driving path candidate.

In S306, the autonomous driving control apparatus 100 may calculate a grid map.

As an example, the autonomous driving control apparatus 100 may calculate a grid map around the host vehicle or the driving path candidate.

As an example, information about the risk according to whether the object is occupied, whether the object will be occupied in the future, a probability that the object will be occupied, a type of the object which be occupied or will be occupied, or the like may be reflected in each grid of the grid map.

In S307, the autonomous driving control apparatus 100 may determine a risk of each of an object and a structure.

As an example, the autonomous driving control apparatus 100 may determine a risk to the driving path candidate, based on the grid map and the path area swept by the part or all of the body of the autonomous vehicle.

In S308, the autonomous driving control apparatus 100 may determine driving stability based a curvature.

As an example, the autonomous driving control apparatus 100 may determine driving stability for the driving path candidate based on a curvature of the driving path candidate.

In S309, the autonomous driving control apparatus 100 may determine a detour degree based on a detour time and a detour distance.

As an example, the autonomous driving control apparatus 100 may determine a distance detoured by the driving path candidate or a time delayed as the driving path candidate is detoured, on the basis of a predetermined reference path.

In S310, the autonomous driving control apparatus 100 may determine an optimal driving strategy.

As an example, the autonomous driving control apparatus 100 may determine the optimal driving strategy based on the risk, the driving stability, and the detour degree.

The optimal driving strategy may include forward vehicle following information about the determined driving path, a maximum speed condition of the road, and/or a maximum speed condition according to a curvature of the driving path.

In S311, the autonomous driving control apparatus 100 may output a speed profile.

As an example, the autonomous driving control apparatus 100 may output a speed profile according to the forward vehicle following information, the maximum speed condition of the road, and/or the maximum speed condition according to the curvature of the driving path.

In S312, the autonomous driving control apparatus 100 may output a control following path.

As an example, the autonomous driving control apparatus 100 may output a movement path of a tractor part according to the driving path as a control following path.

In S313, the autonomous driving control apparatus 100 may perform control to follow the control following path and the speed profile.

As an example, the autonomous driving control apparatus 100 may perform autonomous driving of the autonomous vehicle according to the control following path and the speed profile.

It is shown that S301 to S313 are performed in order on the drawing, but, according an exemplary embodiment, as long as there is no problem with the implementation, some thereof may be performed in a different order or at the same time.

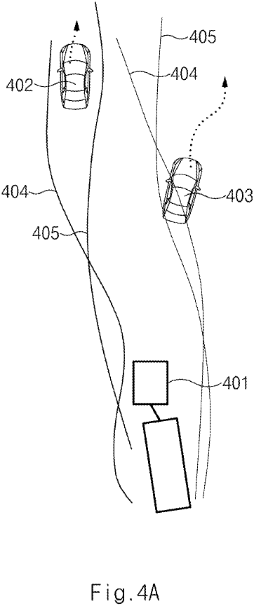

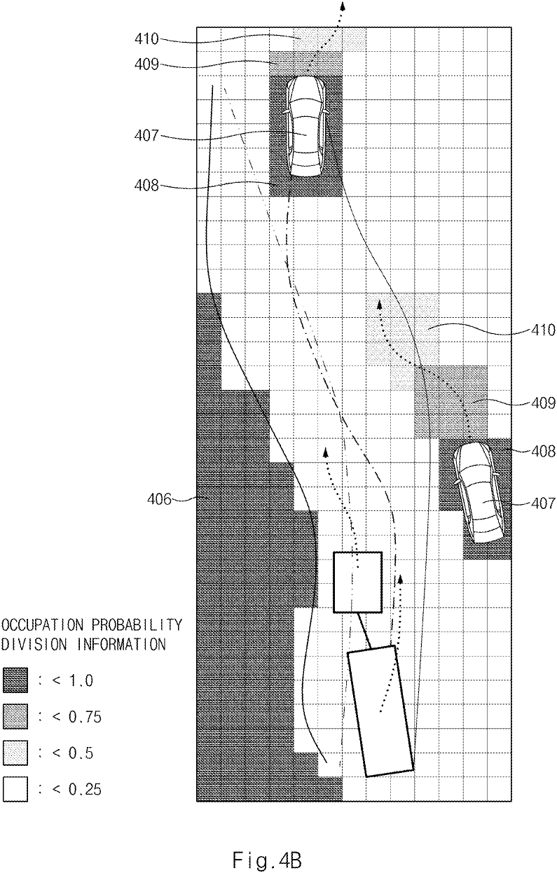

FIG. 4A and FIG. 4B are drawings illustrating that an autonomous driving control apparatus generates a grid map according to an exemplary embodiment of the present disclosure.

FIG. 4A is a drawing illustrating that an autonomous driving control apparatus 100 calculates a path area swept by a part or all of the body of an autonomous vehicle 401 when the autonomous vehicle 401 travels along a driving path candidate prior to generating a grid map.

The autonomous driving control apparatus 100 may calculate a path area 404 swept by a part or all of the body of the autonomous vehicle 401 according to a first driving path candidate and a path area 405 swept by a part or all of the autonomous vehicle 401 according to a second driving path candidate on a high definition map.

As an example, the autonomous driving control apparatus 100 may calculate a left boundary and a right boundary of the path area 404 swept by the part or all of the body of the autonomous vehicle 401 according to the first driving path candidate on the high definition map and may calculate a left boundary and a right boundary of the path area 405 swept by the part or all of the autonomous vehicle 401 according to the second driving path candidate on the high definition map.

Furthermore, the autonomous driving control apparatus 100 may detect objects 402 and 403 around the driving path candidate by means of one or more sensors and may output the objects 402 and 403 around the driving path candidate on the high definition map.

Referring to FIG. 4B, the autonomous driving control apparatus 100 may generate a grid map around the driving path candidate.

The autonomous driving control apparatus 100 may fuse a 2D grid map with high definition map information and may output a path area swept by a part or all of the body of the autonomous vehicle according to a position of the autonomous vehicle, a position of a surrounding object 407, or the driving path candidate on the grid map.

As an example, the autonomous driving control apparatus 100 may classify a type of the detected surrounding object and may determine the object is a fixed object.

As an example, when the object around the autonomous vehicle is the fixed object such as a curb stone, a wall, a sign, a forest, or a structure, the autonomous driving control apparatus 100 may determine that an area occupied by the object will be occupied in the future.

Thus, the autonomous driving control apparatus 100 may determine a probability that an area occupied by the fixed object will be occupied in the future as “1” and may reflect the probability of being occupied in a grid of the grid map.

When the object around the autonomous vehicle is a vehicle, the autonomous driving control apparatus 100 may reflect a driving direction, a speed, or a stop distance of the vehicle to calculate a probability that a position corresponding to the grid of the grid map will be occupied in the future by the object.

As an example, the autonomous driving control apparatus 100 may output the probability of being occupied on the grid map such that a probability that an area corresponding to a grid currently occupied by a vehicle 407 around the autonomous vehicle will be occupied (refer to reference numeral 408) and such that a probability that the area corresponding to the grid will be occupied more is lower as farther from the front.

As an example, the autonomous driving control apparatus 100 may immediately exclude a driving path candidate having a probability of colliding with the fixed object on the grid map.

As an example, the autonomous driving control apparatus 100 may immediately exclude a driving path candidate including a section through which the autonomous vehicle is unable to pass due to a tunnel, a sign, a branch, or the like, according to a height of the autonomous vehicle.

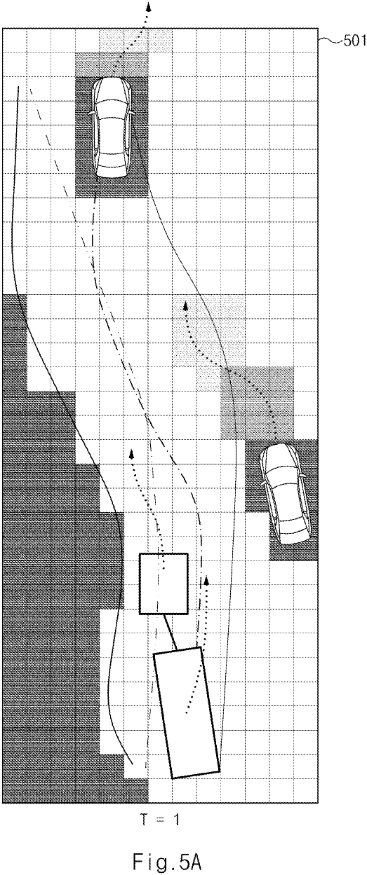

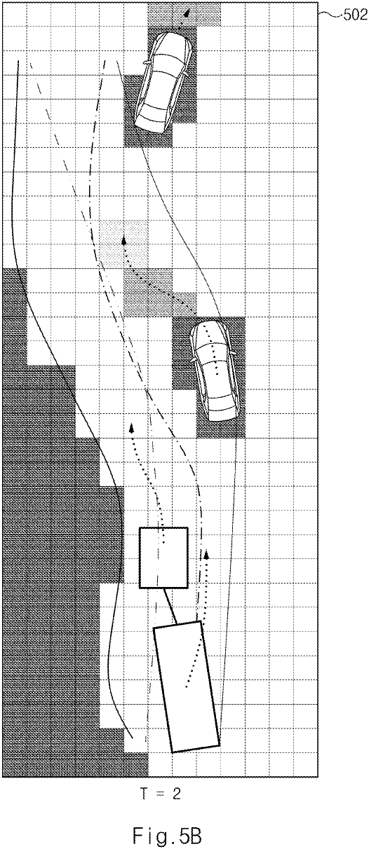

FIGS. 5A and 5B are drawings illustrating that an autonomous driving control apparatus generates a grid map at a future time point according to an exemplary embodiment of the present disclosure.

Referring to FIG. 5A, an autonomous driving control apparatus 100 of FIG. 1 may generate a grid map 501 of a future when a first time period passes.

Referring to FIG. 5B, the autonomous driving control apparatus 100 may generate a grid map 502 of a future when a second time period greater than the first time period passes.

As an example, the autonomous driving control apparatus 100 may output information about a position of the autonomous vehicle, a path area swept by a part or all of the body of the autonomous vehicle according to the driving path candidate, or an area which is occupied or will be occupied by a surrounding object on the grid map for each time.

As an example, the autonomous driving control apparatus 100 may output a probability of being occupied such that the probability of being occupied is lower as the distance increases in the direction of progress with respect to a surrounding vehicle depending on the direction of progress of the surrounding vehicle and a speed of the surrounding vehicle on the grid map for each time.

The autonomous driving control apparatus 100 may output the probability of being occupied such that the probability of being occupied is lower as the distance increases in the direction of progress with respect to the surrounding vehicle, such that a driving path including an area of the direction is not preferably selected.

Furthermore, because the more the distance increases in the direction of progress with respect to the surrounding vehicle, the more the probability that the surrounding vehicle will occupy the area in the future deceases, the autonomous driving control apparatus 100 may output a probability that the area will be occupied to be lower.

FIGS. 6A and 6B are drawings illustrating that an autonomous driving control apparatus generates a grid map in which a size of a surrounding vehicle is reflected according to an exemplary embodiment of the present disclosure.

A risk upon collision or a risk a passenger feels may be different from each other depending on a size of a surrounding vehicle or a type of a vehicle.

Thus, an autonomous driving control apparatus 100 of FIG. 1 may reflect a risk of a surrounding object according to a size or a type of the surrounding object in a grid on the grid map.

Referring to FIG. 6A, the autonomous driving control apparatus 100 may generate a virtual height model for a surrounding object and may assign a risk to a grid on a grid map, based on the height model.

As an example, the autonomous driving control apparatus 100 may calculate a height H_{BOX} 604 of the virtual height model, which is proportional to a width W 601, a length L 602, and a height H_{vehicle} 603 of the surrounding object.

As an example, the autonomous driving control apparatus 100 may calculate the height H_{BOX} 604 of the virtual height model in which a type of the surrounding object is reflected.

As an example, the autonomous driving control apparatus 100 may multiply a larger proportional constant in an order of a bus, a construction vehicle, a truck, a sedan, and a two-wheeled vehicle to calculate the height H_{BOX} 604 of the virtual height model.

Furthermore, the autonomous driving control apparatus 100 may calculate an effective distance 605 proportional to a speed Vᵥₑₕ of the surrounding object * a human average reaction time T_{React}.

As an example, the autonomous driving control apparatus 100 may calculate the effective distance 605 proportional to a stop distance.

As an example, the autonomous driving control apparatus 100 may calculate a virtual height model in a form where a height to the effective distance 605 forward on a lane link where the surrounding vehicle is traveling is linearly reduced.

As an example, the autonomous driving control apparatus 100 may calculate a virtual height model in a form where a height to the effective distance 605 in a driving direction along a lane change curve path of the surrounding object is linearly reduced, when the surrounding object makes a lane change.

As an example, the autonomous driving control apparatus 100 may calculate a risk to a grid corresponding to an area occupied by the virtual height model on the grid map to be proportional to a height of the virtual height model of the area.

Referring to FIG. 6B, the autonomous driving control apparatus 100 may calculate a virtual height model in a form where a height to the effective distance 605 proportional to the speed vᵥₑₕ of the surrounding vehicle * the human average reaction time T_{React} forward on a lane link where the surrounding vehicle is traveling is linearly reduced.

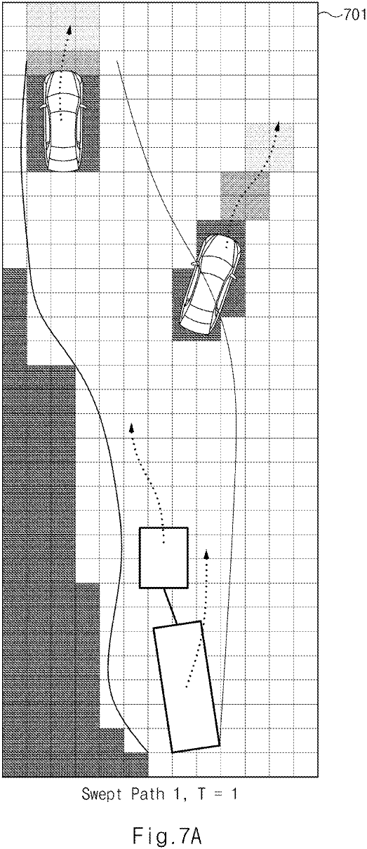

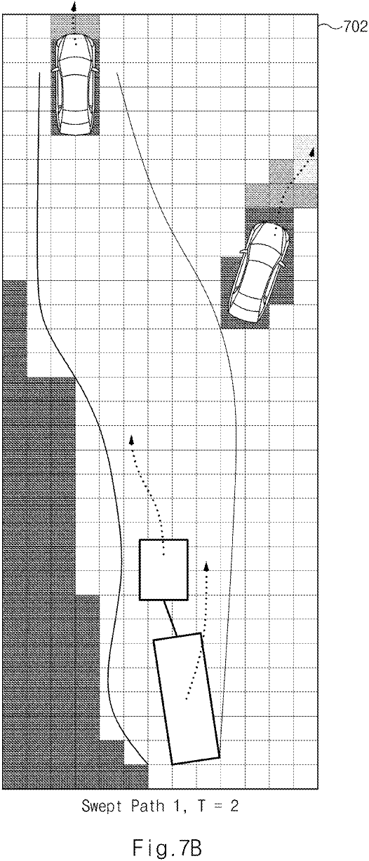

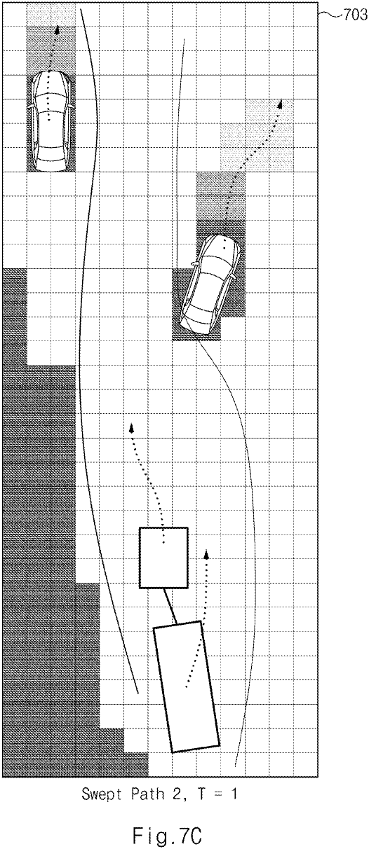

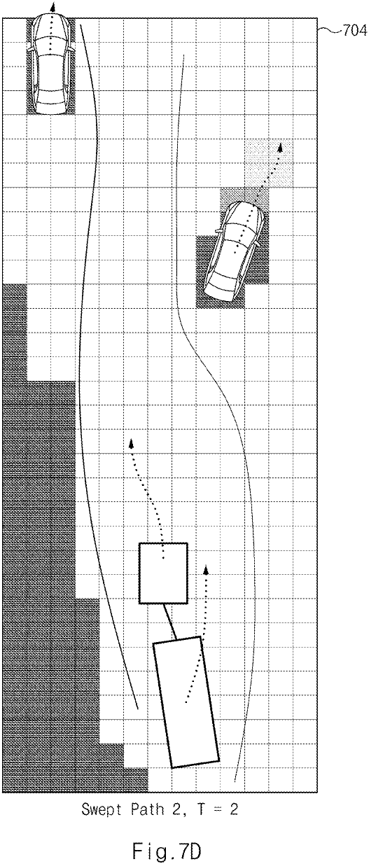

FIGS. 7A, 7B, 7C and 7D are drawings illustrating that an autonomous driving control apparatus compares driving path candidates based on a grid map over time according to an exemplary embodiment of the present disclosure.

701 of FIG. 7A may denote a grid map generated at a first future time point with respect to a first driving path candidate.

702 of FIG. 7B may denote a grid map generated at a second future time point with respect to the first driving path candidate.

703 of FIG. 7C may denote a grid map generated at a first future time point with respect to a second driving path candidate.

704 of FIG. 7D may denote a grid map generated at a second future time point with respect to the second driving path candidate.

As an example, an autonomous driving control apparatus 100 of FIG. 1 may calculate the number of grid cells where there is an object which invades a path area swept by the body of the autonomous vehicle corresponding to the first driving path candidate and the number of grid cells where there is an object which invades a path area swept by the body of the autonomous vehicle corresponding to the second driving path candidate to compare them.

As an example, the autonomous driving control apparatus 100 may apply a weight corresponding to a height of an object which invades a path area swept by the body of the autonomous vehicle on the grid map, depending on each driving path candidate and each time point to score a risk.

As an example, the risk score may be inversely proportional to a risk.

As an example, the autonomous driving control apparatus 100 may compare a value obtained by adding risk scores of respective time points for the first driving path candidate with a value obtained by adding risk scores of respective time points for the second driving path candidate to select a final driving path.

As an example, the autonomous driving control apparatus 100 may compare a value obtained by performing a weighted sum of the risk scores of the respective time points for the first driving path candidate with a value obtained by performing a weighted sum of the risk scores of the respective time points for the second driving path candidate to select a final driving path. Herein, the weight may be determined as a larger value as a risk score is at a time closer to the present.

As an example, the autonomous driving control apparatus 100 may omit to determine a risk at a future time point to obtain a gain of the amount of calculation.

As an example, when a probability of being occupied by an object which invades a path area swept by the body of the autonomous vehicle on the grid map is “1”, the autonomous driving control apparatus 100 may omit to determine a risk to the driving path candidate to obtain a gain of the amount of calculation.

The contents of calculating the two driving path candidates and the risk at the two time points is described as an example in the drawing, but, according to an exemplary embodiment, the autonomous driving control apparatus 100 may calculate risks at one or more time points with respect to two or more driving path candidates and may compare the respective driving path candidates.

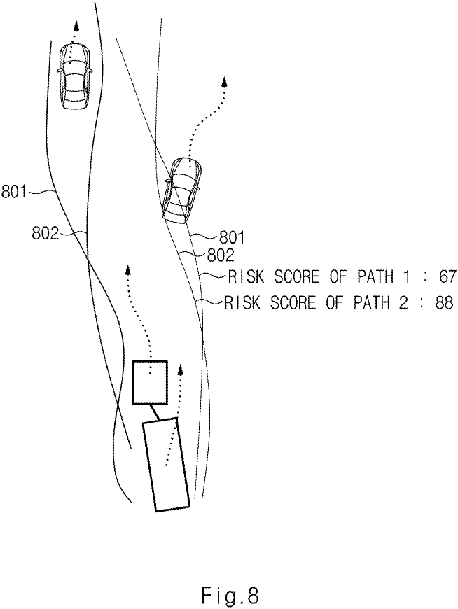

FIG. 8 is a drawing illustrating that an autonomous driving control apparatus determines a risk according to an exemplary embodiment of the present disclosure.

Referring to FIG. 8, an autonomous driving control apparatus 100 of FIG. 1 may calculate risk scores for a path area 801 swept by the body of an autonomous vehicle, corresponding to a first driving path candidate, and a path area 802 swept by the body of an autonomous vehicle, corresponding to a second driving path candidate.

As an example, the autonomous driving control apparatus 100 may calculate a risk score for the first driving path candidate, based on a degree to which a surrounding object invades the path area 801 swept by the body of the autonomous vehicle, corresponding to the first driving path candidate, and may calculate a risk score for the second driving path candidate, based on a degree to which the surrounding object invades the path area 802 swept by the body of the autonomous vehicle, corresponding to the second driving path candidate.

Illustratively, the risk score of the first driving path candidate may be calculated as 67 points, and the risk score of the second driving path candidate may be calculated as 88 points.

As an example, the autonomous driving control apparatus 100 may select the second driving path candidate having the high risk score as a driving path.

The autonomous driving control apparatus 100 may determine the driving path candidate having the highest risk score as the driving path, thus minimizing a possibility that an object such as another vehicle or a structure around the driving path will invade the path area swept by the body of the autonomous vehicle.

As an example, the autonomous driving control apparatus 100 may determine a driving path, based on driving stability and a detour degree together with the risk score.

At this time, the autonomous driving control apparatus 100 may determine the driving path based on weighted average using a weight set to be higher in an order of the risk score, the driving stability score, and the detour degree score.

Herein, the two driving path candidates are illustrative, but the autonomous driving control apparatus 100 may compare scores for two or more driving path candidates and may determine a driving path candidate having the highest score as a driving path.

FIG. 9A and FIG. 9B are drawings illustrating that an autonomous driving control apparatus determines driving stability according to another exemplary embodiment of the present disclosure.

Referring to FIG. 9A, an autonomous driving control apparatus 100 of FIG. 1 may calculate a curvature score of a first driving path candidate 901 as 35 points and may calculate a curvature score of a second driving path candidate 902 as 82 points.

Because the curvature of the first driving path candidate 901 is greater than the curvature of the second driving path candidate 902, the curvature score of the first driving path candidate 901 may be calculated to be lower than the curvature score of the second driving path candidate 902.

As an example, the smaller the curvature of the driving path, the smaller the area of the path area swept by the body of an autonomous vehicle. Thus, a possibility that a surrounding object will invade the path area swept by the body of the autonomous vehicle may be reduced.

Furthermore, because the larger the curvature of the driving path, the more the centripetal force felt by the passenger, riding quality may be degraded.

Thus, the smaller the average curvature of the driving path candidates, the higher the autonomous driving control apparatus 100 may calculate a curvature score of the driving path candidate to be.

Referring to FIG. 9B, the autonomous driving control apparatus 100 may calculate a curvature score, based on a maximum curvature or a total curvature for a driving path candidate.

As another example, the autonomous driving control apparatus 100 may calculate a curvature score, based on an average, a weighted average, a sum, or a weighted sum of the maximum curvature and the total curvature for the driving path candidate.

As an example, the autonomous driving control apparatus 100 may calculate points pnt1, pnt2, ... on the driving path candidate.

As an example, the autonomous driving control apparatus 100 may calculate a straight line connecting the respective points adjacent to each other and may calculate acute angles θ_pnt1, θ_pnt2, ... between the straight lines adjacent to each other.

As an example, the autonomous driving control apparatus 100 may calculate a curvature score to be proportional to the sum of the calculated acute angles θ_pnt1, θ_pnt2, ... or a maximum value among the calculated acute angles θ_pnt1, θ_pnt2, ....

The present disclosure is not limited to the described method. The autonomous driving control apparatus 100 may calculate a curvature score such that the curvature score is lower as the curvature is larger.

As another example, the autonomous driving control apparatus 100 may consider a curvature score based on a curvature of a curve according to a driving path for a tractor part and a curvature score based on a curvature of a curve according to a driving path for a trailer part together to calculate a final curvature score.

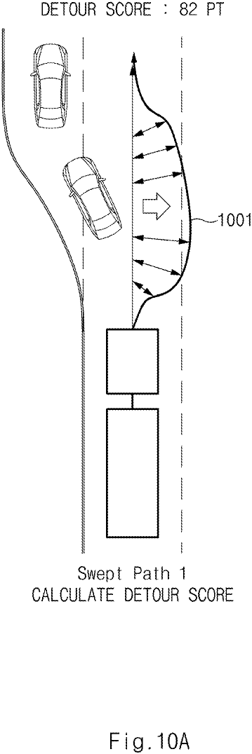

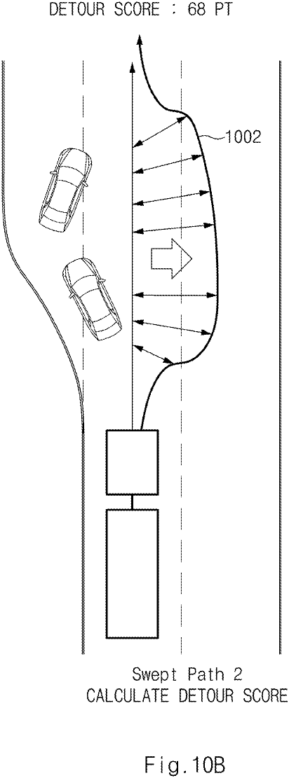

FIG. 10A and FIG. 10B are drawings illustrating that an autonomous driving control apparatus determines a detour degree according to an exemplary embodiment of the present disclosure.

FIG. 10A illustrates calculating a detour degree score according to a first driving path candidate 1001. FIG. 10B illustrates calculating a detour degree score according to a second driving path candidate 1002.

As an example, an autonomous driving control apparatus 100 of FIG. 1 may calculate detour degree scores for the driving path candidates 1001 and 1002 with respect to a predetermined reference path.

As an example, the autonomous driving control apparatus 100 may calculate a detour degree score according to the first driving path candidate 1001 as 82 points and may calculate a detour degree score according to the second driving path candidate 1002 as 68 points.

As an example, because a detour distance of the first driving path candidate 1001 with respect to the reference path is shorter than a detour distance of the second driving path candidate 1002 with respect to the reference path, the autonomous driving control apparatus 100 may calculate a detour degree score of the first driving path candidate 1001 to be higher than a detour degree score of the second driving path candidate 1002.

As an example, because a detour time of the first driving path candidate 1001 with respect to the reference path is shorter than a detour time of the second driving path candidate 1002 with respect to the reference path, the autonomous driving control apparatus 100 may calculate a detour degree score of the first driving path candidate 1001 to be higher than a detour degree score of the second driving path candidate 1002.

As an example, the autonomous driving control apparatus 100 may calculate the shortest distance between respective points making up the reference path and the driving path candidates 1001 and 1002.

As an example, the autonomous driving control apparatus 100 may add or average the shortest distances calculated for the respective points making up the reference path to calculate detour degree scores for the driving path candidates 1001 and 1002.

As an example, the autonomous driving control apparatus 100 may calculate detour degree scores of the driving path candidates 1001 and 1002 inversely proportional to the detour time for the reference path.

As an example, the autonomous driving control apparatus 100 may combine the detour distances and the detour times for the driving path candidates 1001 and 1002 to calculate a detour degree score.

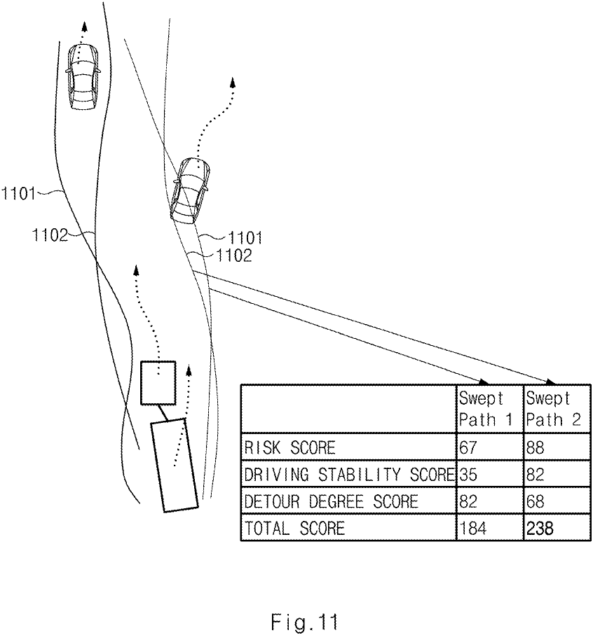

FIG. 11 is a drawing illustrating that an autonomous driving control apparatus determines a final driving path according to an exemplary embodiment of the present disclosure.

Referring to FIG. 11, an autonomous driving control apparatus 100 of FIG. 1 may add a risk score, a driving stability score, and a detour degree score for a first driving path candidate 1101 to calculate a total score and add a risk score, a driving stability score, and a detour degree score for a second driving path candidate 1102 to calculate a total score.

As an example, the autonomous driving control apparatus 100 may compare the total score of the first driving path candidate 1101 with the total score of the second driving path candidate 1102 to determine a final driving path.

In an example, the autonomous driving control apparatus 100 assigns all of weights for the risk score, the driving stability score, and the detour degree score to “1” to calculate the total score. However, according to an exemplary embodiment, the autonomous driving control apparatus 100 may assign different weights to calculate a weighted average of the risk score, the driving stability score, and the detour degree score as a total score.

Furthermore, the autonomous driving control apparatus 100 may calculate total scores based on a risk score, a driving stability score, and a detour degree score, with respect to two or more driving path candidates and may compare the calculated total scores to determine a driving path candidate having the highest total score as a final driving path.

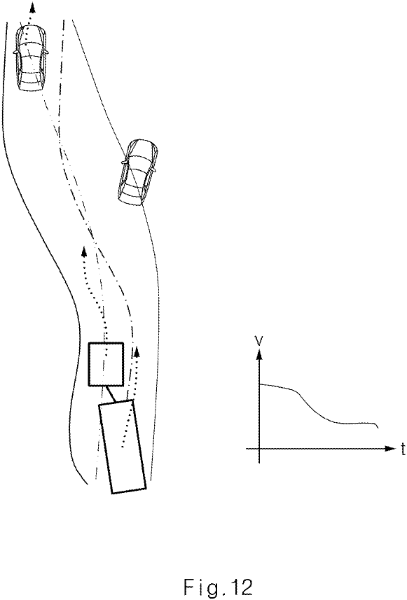

FIG. 12 is a drawing illustrating that an autonomous driving control apparatus calculates a speed profile according to an exemplary embodiment of the present disclosure.

Referring to FIG. 12, an autonomous driving control apparatus 100 of FIG. 1 may calculate a speed profile depending on the determined driving path.

As an example, the autonomous driving control apparatus 100 may calculate a speed profile according to a forward vehicle, a maximum speed condition of the road, and a maximum speed condition according to a curvature of the road depending on the determined driving path.

As an example, when it is expected that there will be a forward vehicle on the driving path, the autonomous driving control apparatus 100 may calculate a speed profile such that the driving speed is less than a specific speed.

As an example, the autonomous driving control apparatus 100 may calculate a speed profile within the range of complying with the speed limit, according to the speed limit of the road included in the driving path.

As an example, to prevent the vehicle from overturning in a curve section, the autonomous driving control apparatus 100 may calculate a speed profile to be less than a specific speed corresponding to a curvature of the specific section of the driving path.

As an example, the autonomous driving control apparatus 100 may calculate a speed profile depending on a distance to a forward vehicle or a forward target and a speed of the forward vehicle or the forward target.

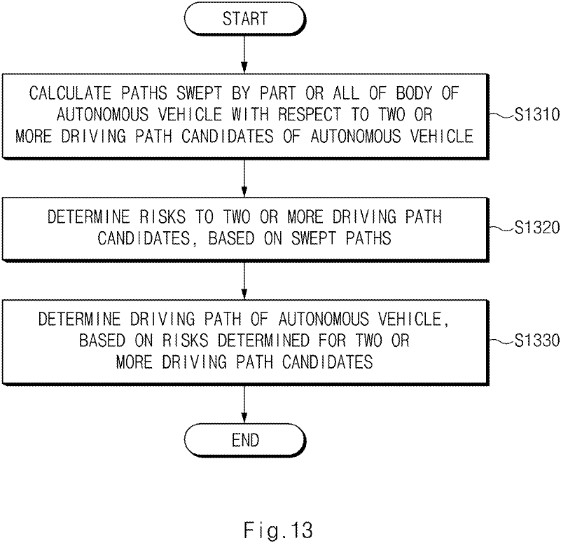

FIG. 13 is a flowchart illustrating an autonomous driving control method according to an exemplary embodiment of the present disclosure.

Referring to FIG. 13, the autonomous driving control method may include calculating (S1310) paths swept by a part or all of the body of an autonomous vehicle with respect to two or more driving path candidates of the autonomous vehicle, determining (S1320) risks to the two or more driving path candidates, based on the swept paths, and determining (S1330) a driving path of the autonomous vehicle, based on the risks determined for the two or more driving path candidates.

The calculating (S1310) of the paths swept by the part or all of the body of the autonomous vehicle with respect to the two or more driving path candidates of the autonomous vehicle may be performed by a path calculation device 110 of FIG. 1.

The determining (S1320) of the risks to the two or more driving path candidates, based on the swept paths, may be performed by a controller 120 of FIG. 1.

As an example, the determining (S1320) of the risks to the two or more driving path candidates may include generating, by the controller 120, a grid map where information about at least one of a position occupied by an object around each of the two or more driving path candidates or a position determined as being occupied in the future by each of the two or more driving path candidates is reflected in a grip and determining, by the controller 120, the risks, based on the grid map and the swept paths.

The generating of the grid map by the controller 120 may include calculating, by the controller 120, a probability that the object will occupy a position corresponding to the grid in the future and generating, by the controller 120, the grid map where the probability is reflected in the grid.

The determining (S1330) of the driving path of the autonomous vehicle, based on the risks determined for the two or more driving path candidates, may be performed by the controller 120.

As an example, the autonomous driving control method may further include determining, by the controller 120, driving stability for each of the two or more driving path candidates, based on a curvature of each of the two or more driving path candidates.

As an example, the determining (S1330) of the driving path of the autonomous vehicle may include determining, by the controller 120, the driving path according to the driving stability.

As an example, the autonomous driving control method may further include determining, by the controller 120, a detour degree corresponding to each of the two or more driving path candidates, based on at least one of a detour distance or a detour time of each of the two or more driving path candidates, according to a reference path.

As an example, the determining (S1330) of the driving path of the autonomous vehicle may include determining, by the controller 120, the driving path according to the detour degree.

As an example, the determining (S1330) of the driving path of the autonomous vehicle may include calculating, by the controller 120, at least one of scores according to the risks, a score according to the driving stability, or a score according to the detour degree and determining, by the controller 120, the driving path of the autonomous vehicle, based on a weighted sum or a weighted average of at least one of the scores according to the risks, the score according to the driving stability, or the score according to the detour degree.

The operations of the method or the algorithm described in connection with the embodiments disclosed herein may be embodied directly in hardware or a software module executed by the processor or in a combination thereof. The software module may reside on a storage medium (that is, the memory/or the storage) such as a RAM, a flash memory, a ROM, an EPROM, an EEPROM, a register, a hard disk, a removable disk, and a CD-ROM.

The exemplary storage medium may be coupled to the processor, and the processor may read information out of the storage medium and may record information in the storage medium. Alternatively, the storage medium may be integrated with the processor. The processor and the storage medium may reside in an application specific integrated circuit (ASIC). The ASIC may reside within a user terminal. In another case, the processor and the storage medium may reside in the user terminal as separate components.

A description will be given of effects of the autonomous driving control apparatus and the method thereof according to an exemplary embodiment of the present disclosure.

According to at least one of embodiments of the present disclosure, the autonomous driving control apparatus and the method thereof may be provided to determine a driving path of an autonomous vehicle.

Furthermore, according to at least one of embodiments of the present disclosure, the autonomous driving control apparatus and the method thereof may be provided to improve driving stability of an autonomous vehicle including a tractor and a trailer.

Furthermore, according to at least one of embodiments of the present disclosure, the autonomous driving control apparatus and the method thereof may be provided to prevent a risk of collision between a trailer and an object.

Furthermore, according to at least one of embodiments of the present disclosure, the autonomous driving control apparatus and the method thereof may be provided to improve riding quality of a user according to a curvature of a path.

Furthermore, according to at least one of embodiments of the present disclosure, the autonomous driving control apparatus and the method thereof may be provided to minimize a detour distance to provide natural driving like a person actually drives the autonomous vehicle.

In addition, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, embodiments of the present invention are not intended to limit the technical spirit of the present invention, but provided only for the illustrative purpose. The scope of the present disclosure should be construed on the basis of the accompanying claims, and all the technical ideas within the scope equivalent to the claims should be included in the scope of the present disclosure.

What is claimed is:

1. An autonomous driving control apparatus, comprising:
a path calculation device configured to calculate paths swept by a part or all of a body of an autonomous vehicle with respect to two or more driving path candidates of the autonomous vehicle; and
a controller configured to determine risks for the two or more driving path candidates based on the swept paths, and to determine a driving path of the autonomous vehicle based on the risks determined for the two or more driving path candidates.

2. The autonomous driving control apparatus of claim 1, wherein the autonomous vehicle includes a tractor part and a trailer part, and
wherein the path calculation device calculates the paths swept by the part or all of the body of the autonomous vehicle, based on a path swept by the tractor part with respect to each of the two or more driving path candidates and a path swept by the trailer part with respect to each of the two or more driving path candidates.

3. The autonomous driving control apparatus of claim 1, wherein the controller determines the risks, based on the swept paths, according to at least one of a position occupied by an object around each of the two or more driving path candidates or a position determined as being occupied in a future by the object around each of the two or more driving path candidates.

4. The autonomous driving control apparatus of claim 3, wherein the controller generates a grid map where information about the at least one of the position occupied by the object around each of the two or more driving path candidates or the position determined as being occupied in the future by the object around each of the two or more driving path candidates is reflected in a grid, and determines the risks based on the grid map and the swept paths.

5. The autonomous driving control apparatus of claim 4, wherein the controller generates the grid map with respect to a current time point and the grid map with respect to a future time point, and determines the risks based on the grid map with respect to the current time point, the grid map with respect to the future time point, and the swept paths.

6. The autonomous driving control apparatus of claim 4, wherein the controller generates the grid map where information about at least one of a size or a type of a vehicle around each of the two or more driving path candidates is reflected in the grid.

7. The autonomous driving control apparatus of claim 4, wherein the controller calculates a probability that the object will occupy a position corresponding to the grid in the future and generates the grid map where the probability is reflected in the grid.

8. The autonomous driving control apparatus of claim 7, wherein the controller calculates the probability that the object will occupy the position corresponding to the grip in the future, based on at least one of a driving direction, a speed, or a stop distance of the object.

9. The autonomous driving control apparatus of claim 1, wherein the controller determines at least one of driving stability or a detour degree corresponding to each of the two or more driving path candidates, and determines the driving path according to the at least one of the driving stability or the detour degree.

10. The autonomous driving control apparatus of claim 9, wherein the controller determines the driving stability based on a curvature of each of the two or more driving path candidates.

11. The autonomous driving control apparatus of claim 10, wherein the controller determines the driving stability based on at least one of an average curvature of the two or more driving path candidates, a maximum curvature of the two or more driving path candidates, or a weighted average of the average curvature and the maximum curvature.

12. The autonomous driving control apparatus of claim 9, wherein the controller determines the detour degree based on at least one of a detour distance or a detour time of each of the two or more driving path candidates, according to a reference path.

13. The autonomous driving control apparatus of claim 9, wherein the controller calculates at least one of scores according to the risks, a score according to the driving stability, or a score according to the detour degree, and determines the driving path of the autonomous vehicle based on a weighted sum or a weighted average of at least one of the scores according to the risks, the score according to the driving stability, or the score according to the detour degree.

14. The autonomous driving control apparatus of claim 1, wherein the controller determines a following speed based on at least one of a curvature of the driving path or a forward object on the path, which corresponds to the driving path, swept by the part or all of the body of the autonomous vehicle, and performs autonomous driving control of the autonomous vehicle depending on the following speed.

15. An autonomous driving control method, comprising:
calculating, by a path calculation device, paths swept by a part or all of a body of an autonomous vehicle with respect to two or more driving path candidates of the autonomous vehicle;
determining, by a controller, risks for the two or more driving path candidates based on the swept paths; and
determining, by the controller, a driving path of the autonomous vehicle based on the risks determined for the two or more driving path candidates.

16. The autonomous driving control method of claim 15, wherein the determining of the risks for the two or more driving path candidates by the controller includes:
generating, by the controller, a grid map where information about at least one of a position occupied by an object around each of the two or more driving path candidates or a position determined as being occupied in a future by the object around each of the two or more driving path candidates is reflected in a grid; and
determining, by the controller, the risks based on the grid map and the swept paths.

17. The autonomous driving control method of claim 16, wherein the generating of the grid map by the controller includes:
calculating, by the controller, a probability that the object will occupy a position corresponding to the grid in the future; and
generating, by the controller, the grid map where the probability is reflected in the grid.

18. The autonomous driving control method of claim 15, further comprising:
determining, by the controller, driving stability corresponding to each of the two or more driving path candidates based on a curvature of each of the two or more driving path candidates,
wherein the determining of the driving path of the autonomous vehicle by the controller includes:
determining, by the controller, the driving path according to the driving stability.

19. The autonomous driving control method of claim 15, further comprising:
determining, by the controller, a detour degree corresponding to each of the two or more driving path candidates based on at least one of a detour distance or a detour time of each of the two or more driving path candidates, according to a reference path,
wherein the determining of the driving path of the autonomous vehicle by the controller includes:
determining, by the controller, the driving path according to the detour degree.

20. The autonomous driving control method of claim 15, further comprising:
determining, by the controller, at least one of driving stability or a detour degree corresponding to each of the two or more driving path candidates,
wherein the determining of the driving path of the autonomous vehicle by the controller includes:
calculating, by the controller, at least one of scores according to the risks, a score according to the driving stability, or a score according to the detour degree; and
determining, by the controller, the driving path of the autonomous vehicle based on a weighted sum or a weighted average of at least one of the scores according to the risks, the score according to the driving stability, or the score according to the detour degree.
